(19) United States
(12) Patent Application Publication
(10) Pub. No.: US 2026/0260170 A1
(43) Pub. Date: Sep. 3, 2026

(54) SYSTEM AND METHOD FOR MANAGING AN ON-SENSOR MACHINE LEARNING (ML) MODEL

(71) Applicant: ABB Schweiz AG, Baden (CH)

(72) Inventors: Madapu Amarlingam, Vikarabad (IN); Santonu Sarkar, Bangalore (IN); Jan-Christoph Schlake, Darmstadt (DE)

(73) Assignee: ABB Schweiz AG, Baden (CH)

(21) Appl. No.: 19/650,974

(22) Filed: Apr. 17, 2026

Related U.S. Application Data
(63) Continuation of application No. PCT/IB2023/060518, filed on Oct. 18, 2023.

(51) Int. Cl. G06N 20/00; G06F 11/07; G06F 11/34

(52) U.S. Cl. CPC G06N 20/00; G06F 11/0793; G06F 11/3466

(57) ABSTRACT

A system and method for managing an on-sensor machine learning (ML) model includes monitoring performance parameters of plurality of on-sensor ML models present in an industrial plant; detecting a degradation of at least one on-sensor ML model based on the monitored ML model performance parameters of the plurality of on-sensor ML models, wherein degradation of the at least one on-sensor ML model comprises at least one of: data distribution change, training serving skew, model drift, occurrence of outlier event, and data quality issue; and updating the at least one on-sensor ML model based on the ML model upgradation parameters retrieved from one of the plurality of sources.

### CROSS-REFERENCE TO RELATED APPLICATIONS

The instant application claims priority to International Patent Application No. PCT/IB2023/060518, filed Oct. 18, 2023, which is incorporated herein in its entirety by reference.

### FIELD OF THE DISCLOSURE

The present disclosure generally relates to a machine learning system and, more particularly, to systems and methods for managing an on-sensor machine learning (ML) model.

### BACKGROUND OF THE INVENTION

Industry 4.0 is revolutionizing the way companies manufacture, improve and distribute their products. Manufacturers are integrating new technologies, including Internet of Things (IoT), cloud computing and analytics, Artificial Intelligence (AI) and machine learning into their production facilities and throughout their operations.

Industry 4.0 requires analyzing and optimizing the production process and production cycle in process automation and getting insight into process and equipment conditions. For example, asset condition monitoring reduces the downtime of a plant. Sensors and Analyzer play a key role for collecting the process and equipment condition information and feeding to analytics for quicker and accurate insights from assets. The current trend of collecting the sensor data and moving the data from sensor to an edge or cloud for analytics applications lacks modularity and compromises with data security and privacy.

As resource constrained machine learning (ML) is becoming realizable on low-end devices, the current trend is moving towards sensor 2.0, i.e., smart sensor. Smart sensors are gaining attraction as process automation is moving towards Industry 4.0. Data patterns in process industry change due to process elements, process conditions, and environmental effects. Various industrial plants have implemented smart sensors to monitor the performance of various motors. In sensor 2.0, an ML model is directly embedded into a physical sensor board and directly produces decisions or predictions. Thus, the direct output of on-sensor ML models is used instead of raw data and external models.

However, the ML models' performance gets degraded over time due to change in data pattern of sensors and the ML model produces inaccurate decisions or predictions that may cause a process plant to shut down due to bad operator/maintenance decisions based on sensor values.

While the deployment of ML sensors is an approach towards the industry 4.0. For the operator in the plant receiving the diagnostic messages from the sensor or from the ML model, it is necessary to have summary information highlighting whether certain sensor value is anomalous and detailed diagnostic information to understand the root cause of anomaly. Further, the presently available smart sensors fail to adapt to changing conditions. For example, the on-sensor ML model performance degrades with time, which leads to faulty predictions, plant shutdowns, and re-deployments, thereby adding to the OpEx.

### BRIEF SUMMARY OF THE INVENTION

In view of the foregoing discussion, there exists a need in the art to provide a method and a system which overcomes the stated problems by efficiently managing and upgrading an on-sensor ML model from time to time to provide continuous accurate predictions.

In one non-limiting embodiment of the present disclosure, a method for managing an on-sensor machine learning (ML) model is disclosed. The method comprises the step of monitoring performance parameters of plurality of on-sensor ML models present in an industrial plant. The method further comprises the step of detecting a degradation of at least one on-sensor ML model based on the monitored ML model performance parameters of the plurality of on-sensor ML models. The degradation of the at least one on-sensor ML model comprises at least one of: data distribution change, training serving skew, model drift, occurrence of outlier event, and data quality issue. The method finally discloses the step of updating the at least one on-sensor ML model based on the ML model upgradation parameters retrieved from one of the plurality of sources.

In another non-limiting embodiment of the present disclosure, a method for upgrading an on-sensor machine learning (ML) model is disclosed. The method comprises the step of receiving a request for updating an on-sensor machine learning (ML) model from an end user. The request comprises one or more application requirements from at least one sensor comprising the on-sensor machine learning (ML) model. The method then discloses the step of retrieving ML model upgradation parameters corresponding to the one or more application requirements from one of the plurality of sources. The method finally discloses the step of transmitting the ML model upgradation parameters to the at least one sensor for training the on-sensor ML model.

In yet another embodiment of the present disclosure, a system for managing an on-sensor machine learning (ML) model is disclosed. The system includes a memory and at least one processor coupled to the memory. The at least one processor is configured to monitor performance parameters of plurality of on-sensor ML models present in an industrial plant and detect a degradation of at least one on-sensor ML model based on the monitored ML model performance parameters of the plurality of on-sensor ML models. The degradation of the at least one on-sensor ML model comprises at least one of: data distribution change, training serving skew, model drift, occurrence of outlier event, and data quality issue. The at least one processor is then configured to retrieve ML model upgradation parameters for the at least one on-sensor ML model, detected with degradation, from one of the plurality of sources and update the at least one on-sensor ML model based on the ML model upgradation parameters retrieved from one of the plurality of sources.

In yet another embodiment of the present disclosure, a system for upgrading an on-sensor machine learning (ML) model is disclosed. The system includes a memory and at least one processor. The at least one processor is configured to receive a request for updating an on-sensor machine learning (ML) model from an end user. The request comprises one or more application requirements from at least one sensor comprising the on-sensor machine learning (ML) model. The at least one processor is then configured to retrieve ML model upgradation parameters corresponding to the one or more application requirements from one of the plurality of sources and transmit the ML model upgradation parameters to the at least one sensor for training the on-sensor ML model.

### BRIEF DESCRIPTION OF THE SEVERAL VIEWS OF THE DRAWING(S)

FIG. 1 is a diagram of an exemplary environment showing a machine learning (ML) sensor implemented in a distributed edge network setting, in accordance with an embodiment of the present disclosure.

FIG. 2 is a block diagram representation of system for managing an on-sensor machine learning (ML) model in accordance with an embodiment of the present disclosure.

FIG. 3 is a block diagram representation of system for managing and upgrading an on-sensor machine learning (ML) model in accordance with another embodiment of the present disclosure.

FIG. 4 is a flowchart for a method for managing an on-sensor machine learning (ML) model, in accordance with an embodiment of the present disclosure.

FIG. 5 is a flowchart for a method for upgrading an on-sensor machine learning (ML) model, in accordance with an embodiment of the present disclosure.

### DETAILED DESCRIPTION OF THE INVENTION

The integration of machine leaning (ML) with sensors benefit areas such as Industry 4.0, Internet of Things, etc. The ML based sensors or the on-sensor ML model is widely used to collect environmental parameters in an industry where they are used for condition monitoring/anomaly detection/quality measurement/prediction. The on-sensor ML model may also be implemented to monitor/measure/predict performance of various devices present in an industry.

The present disclosure describes a method for managing an on-sensor machine learning (ML) model. The on-sensor ML model is trained using historical sensor data that is embedded within the sensor. The method comprises the step of monitoring performance parameters of plurality of on-sensor ML models present in an industrial plant. The method further comprises the step of detecting a degradation of at least one on-sensor ML model based on the monitored ML model performance parameters of the plurality of on-sensor ML models. The degradation of the at least one on-sensor ML model comprises at least one of: data distribution change, training serving skew, model drift, occurrence of outlier event, and data quality issue. The method finally discloses the step of updating the at least one on-sensor ML model based on the ML model upgradation parameters retrieved from one of the plurality of sources. Thus, the method facilitates on-sensor model performance degradation detection and updating the on-sensor model to produce accurate decisions or predictions.

The present further discloses a method for upgrading an on-sensor machine learning (ML) model is disclosed. The method comprises the step of receiving a request for updating an on-sensor machine learning (ML) model from an end user. The request comprises one or more application requirements from at least one sensor comprising the on-sensor machine learning (ML) model. The method then discloses the step of retrieving ML model upgradation parameters corresponding to the one or more application requirements from one of the plurality of sources. The method finally discloses the step of transmitting the ML model upgradation parameters to the at least one sensor for training the on-sensor ML model. Thus, the method facilitates on request on-sensor ML model upgradation for adaptive functionality based on application requirement.

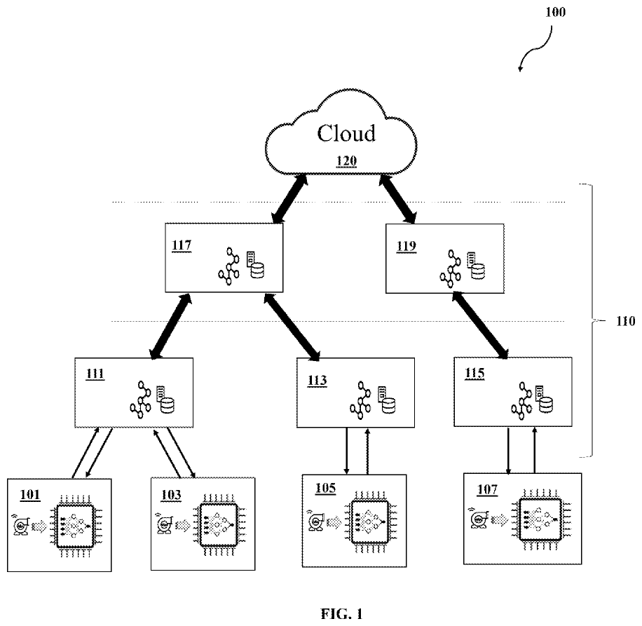

FIG. 1 illustrates an exemplary environment 100 of machine learning (ML) sensor implemented in a distributed edge network setting, in accordance with an embodiment of the present disclosure.

In an embodiment of the present disclosure, the environment 100 may comprise a plurality of ML based sensors 101, 103, 105, 107, . . . , a distributed edge network 110, and a cloud 120. Each of the plurality of ML based sensors 101, 103, 105, 107 may comprise a respective on-sensor ML model for condition monitoring/anomaly detection/quality measurement/prediction. The on-sensor ML model may be embedded into each sensor. In one non-limiting embodiment, technologies such as TinyML may be applied to generate light-weight ML models and embed those ML models into the sensors to directly compile the ML code for the target software architecture platform.

In one non-limiting embodiment, the environment 100 may implemented in an industry or process industry such oil and gas industry, chemical industry, mining industry, pulp and paper industry, metal or steel industry, food and beverage industry, battery manufacturing, etc. However, the industry is not limited to above example and may comprise any other industry that implements ML sensors or on-sensor ML models.

The distributed edge network 110 may comprise one or more edge nodes. FIG. 1 shows presence of plurality of edge nodes 111, 113, 115, 117, and 119 distributed over multiple layers in the distributed edge network 110. However, the number of edge nodes in a distributed network is not limited and may include more or fewer of those in the above example as per the application or industry in which the distributed edge network 110 is implemented.

As shown in FIG. 1, the plurality of ML based sensors 101, 103, 105, 107, . . . , the distributed edge network 110, and the cloud 120 are represented in a hierarchy. The plurality of ML based sensors 101, 103, 105, and 107 form the bottom layer, which is implemented industrial plant. In one non-limiting embodiment, the ML based sensors 101, 103, 105, 107 may be deployed along with machine and device in an industrial plant. The distributed edge network 110 may comprise plurality of edge layers and each layer may include one or more edge nodes. The edge layer closer or next to the plurality of ML based sensors are treated as lower edge layer and the edge layer closer or next to the cloud 120 are treated as upper edge layer. The lower edge nodes 111, 113, 115 may be directly coupled to the plurality of ML based sensors 101, 103, 105, 107, and the upper edge nodes 117, 119 may be directly coupled to the cloud 120, as shown in FIG. 1. However, the number of edge layers in a distributed edge network 110 is not limited to above example and any number of edge layers may be implemented in an industrial plant based on the application requirements and the industrial plant.

The degradation detection of the on-sensor ML model of the plurality of ML based sensors 101, 103, 105, 107 and upgradation of the on-sensor ML model is discussed in further detail in the embodiments below.

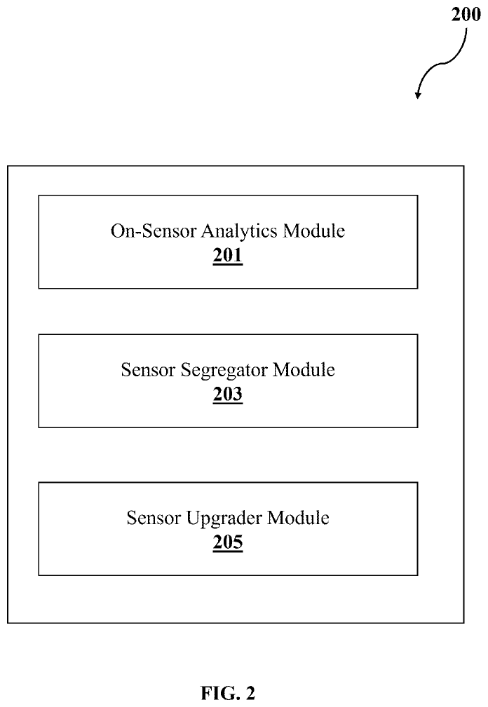

FIG. 2 illustrates a block diagram representation of system 200 for managing an on-sensor machine learning (ML) model, in accordance with an embodiment of the present disclosure.

In an embodiment of the present disclosure, the system 200 may be implemented in a core process network. The system 200 may be implemented for maintaining and updating ML sensor models in an industrial environment or space. The system 200 may comprise lightweight managing modules that track the performance of the on-sensor ML models, detect the on-sensor ML model performance degradation, and update the on-sensor ML model with the help of a distributed edge network.

The system 200 may comprise an on-sensor analytics module 201, a sensor segregator module 203, and a sensor upgrader module 205 in communication with each other. In one non-limiting embodiment, the on-sensor analytics module 201 may be implemented inside the ML sensors 101, 103, 105, and 107, whereas the sensor segregator module 203 and the sensor upgrader module 205 may be implemented inside the edge nodes in the distributed edge network 110. The sensor segregator module 203 and the sensor upgrader module 205 are distributed across the edge network to keep the solution lightweight and ensure smooth operations of the ML based sensors.

In one non-limiting embodiment, the on-sensor analytics module 201, the sensor segregator module 203, and the sensor upgrader module 205 may be hardware module comprising memory and at least one processor for performing the operations mentioned below. In another non-limiting embodiment, the on-sensor analytics module 201, the sensor segregator module 203, and the sensor upgrader module 205 may be software modules or a combination of hardware and software modules for performing the operations mentioned below.

In an embodiment of the present disclosure, the on-sensor analytics module 201 may be configured to monitor performance parameters of plurality of on-sensor ML models belonging to plurality of ML sensors or sensors present in an industrial plant. The performance parameters are monitored by monitoring the input parameters and output parameters of the on-sensor ML models. In case the on-sensor analytics module 201 is implemented inside the ML sensor, then the on-sensor analytics module 201 of each ML sensor may monitor the performance parameters of their respective on-sensor ML model.

The on-sensor analytics module 201 may be then configured to detect a degradation of on-sensor ML model by on-sensor drift detection. The on-sensor drift detection or the degradation of on-sensor ML model may comprise data distribution change, training serving skew, model drift, occurrence of outlier event, and data quality issue.

The data distribution change may occur when there is change in production and the sensor produces different result data than before. The sensor output provides as input to the on-sensor ML model and the on-sensor ML model may not be trained on this data and provide poor/unforeseen results. In one embodiment, the on-sensor analytics module 201 may be configured to measure the data distribution change by performing one or more data distribution tests on the at least one on-sensor ML model using distance metrics. The distance metrics may comprise basic statistical metrics to test drift between historical and current parameters, e.g. mean/average value, standard deviation, minimum and maximum values comparison, and correlation. The distance metrics may further comprise continuous features use e.g. Kullback-Leibler divergence, Kolmogorov-Smirnov statistics (widely used), Population Stability Index (PSI), Hellinger distance. The distance metrics may also comprise categorical features, use e.g. chi-squared test, entropy, the cardinality or frequency of the feature. In one non-limiting embodiment, the on-sensor analytics module 201 may identify the data distribution change based on the changes in input parameters and output parameters, which are compared with their respective thresholds. The respective thresholds may be defined during the training of the on-sensor ML model.

The training serving skew may occur when the on-sensor ML model is trained based on wrong data and hence the on-sensor ML model is performing poorly. The on-sensor analytics module 201 may determine the training serving skew i.e., the modeling error by verifying the training parameters used for training the on-sensor ML model.

The model/concept drift may occur as machines/devices present in the industrial environment ages that lead to change in sensor output and the on-sensor ML model may not be calibrated to accommodate such change. As a result, the prediction performance degrades with aging of machines/devices. In an embodiment of the present disclosure, the on-sensor analytics module 201 may be configured to a detect/determine reduction in predictive performance of the on-sensor ML model using one or more evaluation metrics. In an embodiment, the one or more evaluation metrics may be like that used for training the on-sensor ML model. The one or more evaluation metrics may comprise F1-Score, precision and recall scores, ROC-AUC score, and confusion matrix. However, the one or more evaluation metrics are not limited to above examples and any other evaluation metrics that may be known to evaluation of the predictive performance is well within the scope of present disclosure.

In another embodiment, the on-sensor analytics module 201 may be configured to determine label drift by monitoring changes in the distribution of real labels of the on-sensor ML model, which are used for supervised learning solutions.

The degradation of the on-sensor ML model may comprise the outlier or extreme events due to which model input changes. Such extreme events are rarely considered while training the on-sensor ML model, which in turn leads to model performance degradation. The on-sensor analytics module 201 may be configured to apply an outlier detection technique to determine one or more outlier events. The outlier detection technique may be one of: statistical method, proximity-based, and model based.

To apply a statistical method, the on-sensor analytics module 201 may be configured to assume that regular/normal data follows a specific statistical model (a stochastic model or distribution). If the data is not following the specific statistical model, the on-sensor analytics module 201 may detect an outlier event.

In proximity-based method, the on-sensor analytics module 201 may be configured to detect data object as an outlier if the nearest neighbours of the data object are far away, i.e., the proximity (e.g., distance) of the data object is significantly deviates from the proximity of most of the other objects in the same data set.

In model-based method or supervised machine learning based method, the on-sensor analytics module 201 may be configured to utilize the classifiers to detect the outliers by learning the labelled data. However, the outlier detection technique is not limited to above examples and any other outlier detection technique for detecting outlier in a data set is well within the scope of the present disclosure.

The degradation of on-sensor ML model may also comprise data quality issues i.e. the input data fed to the on-sensor ML model. The data quality issues may comprise missing or wrong data. The on-sensor analytics module 201 may be configured to perform data quality checks by testing input data for duplicates and missing values, checking syntax errors, data type errors, and format errors, checking schema for semantic errors in terms of feature names, effective data profiling for complex dependencies in the data pipeline, and data integrity checks.

The system 200 comprises the sensor upgrader module 205 and may be configured to retrieve ML model upgradation parameters for the at least one on-sensor ML model for which degradation is degraded. The ML model upgradation parameters may be retrieved from one of the plurality of sources. The plurality of sources may be one of: a local storage, a distributed edge network, or cloud.

In an embodiment, when the on-sensor ML model degrades, the on-sensor upgradation is triggered by the sensor upgrader module 205. The sensor upgrader module 205 may first determine local online learning methods that can be used to update the on-sensor ML model. The local online learning methods and the respective upgradation parameters may be available with the ML sensor itself. If the upgradation parameters for a specific degradation are available for a particular type of degradation, then the sensor upgrader module 205 may be configured to update the on-sensor ML model based on the ML model upgradation parameters. In one non-limiting embodiment, the ML model upgradation parameters may comprise updated model weights for updating the modal weights of the degraded on-sensor ML model.

In an embodiment, when the on-sensor ML model degrades and the local online learning methods to update the on-sensor ML model is not available, the sensor upgrader module 205 may trigger the on-sensor model upgradation with the help of lower edge node present in lower edge layer. If the lower edge node comprises the upgradation parameters for the specific degradation, then the sensor upgrader module 205 may be configured to retrieve the upgradation parameters from the lower edge layer. The lower edge layer may push the upgradation parameters from the lower edge layer to the ML sensor, and the ML sensor may update the on-sensor ML model. For example, federated learning methods can be used to update the model.

When the on-sensor ML model degrades and the upgradation parameters are not available with the lower edge layer, the sensor upgrader module 205 may trigger the on-sensor model upgradation with the help of upper edge node or cloud. If the upper edge node or the cloud comprises the upgradation parameters for the specific degradation, then the sensor upgrader module 205 may be configured to retrieve the upgradation parameters from the upper edge node or the cloud. The upper edge layer lower or the cloud may push the upgradation parameters towards the lower edge layer to the ML sensor, and the ML sensor may update the on-sensor ML model.

The above-mentioned on-sensor ML model upgradation may be understood by considering the exemplary environment 100 of FIG. 1. For example, if the on-sensor analytics module 201 is a part of the ML based sensor 101 and the on-sensor analytics module 201 detects a degradation in on-sensor ML model of ML based sensor 101. The on-sensor analytics module 201 may retrieve the model upgradation parameters from local storage of the ML based sensor 101 and update the on-sensor ML model by local learning methods. If the model upgradation parameters are not available with the local storage of ML based sensor 101, then the on-sensor analytics module 201 may generate an alert for a lower edge node. The sensor upgrader module 205 present inside in the lower edge node 111 may receive the alert and may push the upgradation parameters from the lower edge node 111 to the ML based sensor 101. The on-sensor analytics module 201 retrieves the upgradation parameters from the lower edge node 111 and updates the on-sensor ML model based on the retrieved upgradation parameters. If the model upgradation parameters are not available with the lower edge node 111, then the lower edge node 111 may generate an alert for the upper edge node 117 or cloud 120. The upper edge node 117 or the cloud 120 may receive the alert and may provide the upgradation parameters to the on-sensor analytics module 201. The on-sensor analytics module 201 retrieves the upgradation parameters from the upper edge node 117 or cloud 120 and updates the on-sensor ML model based on the retrieved upgradation parameters.

The upgradation parameters for different types of degradations for each type of ML based sensor may be pre-stored in the distributed edge network. In one non-limiting embodiment, the upgradation parameters for each type of degradation of each type of ML sensor may be initially generated by an administrator by evaluating the type of degradation and the type of sensor. The type of sensor may indicate the parameter which it senses or detects. These upgradation parameters are then prestored at the ML sensor or pushed into the distribution edge network so that upgradation parameters may be used other similar types of sensor having similar degradation to update its on-sensor ML model.

In an embodiment of the present disclosure, the sensor segregator module 203 may be configured to group one or more on-sensor ML models of ML based sensors of an industrial plant at least based on a type of sensor, a type of on-sensor ML model, version of on-sensor ML model, tested accuracy of on-sensor ML model, and size of on-sensor ML model. In one non-limiting embodiment, the sensor segregator module 203 may be present in the lower edge nodes in a distributed edge network setting and may be configured to receive a readable summary or meta information regarding a drift in the on-sensor model of the ML sensor that will be used for grouping the similar ML sensors with similar past events. This information may be useful in tracking and retrieving the upgradation parameters when a degradation is detected in on-sensor model of the ML sensor.

Thus, the system 200 increases the adaptability of ML based sensors to changing conditions in an industrial environment. Further, the system efficiently manages the performance of the on-sensor ML models, thereby leading to accurate predictions and preventing plant shutdowns and re-deployments. In addition, on-sensor ML models of the smart sensor are maintained and updated from time to time to provide continuous accurate predictions.

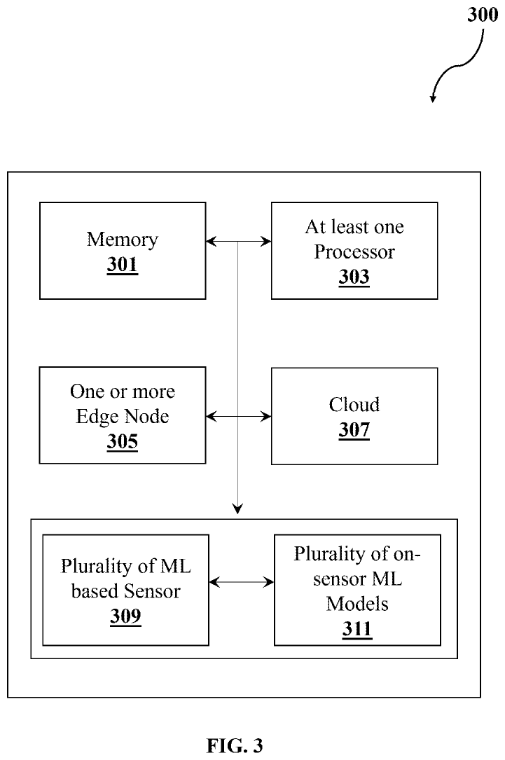

FIG. 3 illustrates a block diagram representation of system 300 for managing and upgrading an on-sensor machine learning (ML) model, in accordance with another embodiment of the present disclosure.

In an embodiment, the system 300 may comprise a memory 301, at least one processor 303, one or more edge node 305, cloud 307, a plurality of ML based sensors 309 and a plurality of on-sensor ML models 311. Each ML based sensor may comprise a respective ML model embedded into the ML based sensor. The one or more edge node 305 may form a distributed edge network 110 as discussed in embodiments of FIG. 1 above. In one non-limiting embodiment, the memory 301 and at least one processor 303 may perform all the functionalities of the on-sensor analytics module 201, the sensor segregator module 203, and the sensor upgrader module 205, as discussed in above embodiments.

The at least one processor 303 may be configured to monitor performance parameters of plurality of on-sensor ML models 311 present in an industrial plant. In one non-limiting embodiment, the at least one processor 303 may present within each of the plurality of ML based sensor 309 and may monitor performance parameters of respective on-sensor ML model of the ML based sensor.

The at least one processor 303 may be then configured to detect a degradation of at least one on-sensor ML model based on the monitored ML model performance parameters of the plurality of on-sensor ML models 311. The degradation of the on-sensor ML model comprises one or more of: data distribution change, training serving skew, model drift, occurrence of outlier event, and data quality issue. The detection of the degradation may be carried out using the procedure discussed in above embodiments.

The at least one processor 303 may be then configured to retrieve ML model upgradation parameters for the on-sensor ML model, detected with degradation, from one of the plurality of sources. The plurality of sources may be one of: a local storage of the ML based sensor 309, distributed edge network, or cloud 307. To retrieve the ML model upgradation parameters for the at least one on-sensor ML model from the distributed edge network, the at least one processor 303 may be configured to retrieve ML model upgradation parameters for the on-sensor ML model from an edge node of an edge layer of the distributed edge network. The ML model upgradation parameters for a specific type of degradation and specific type of sensor may be pre-stored in at least one of local storage of ML sensor, edge network node 305 or cloud 307. The procedure of retrieval of the ML model upgradation parameters from the edge node 305 is same as discussed in explanation of FIG. 2 in above embodiments.

The retrieval procedure for the ML model upgradation parameters may be carried out using bottom to top approach, where the upgradation parameters are first retrieved from the local storage of the ML based sensor 309. If the upgradation parameters are not available with the ML based sensor 309, then an edge layer node next to the ML based sensor 309 is alerted and the upgradation parameters are retrieved from the edge layer node next to the ML based sensor 309. If the upgradation parameters are not available with the edge layer node next to the ML based sensor 309, then an upper edge layer node present next to the previous edge layer node is alerted to retrieve the upgradation parameters from the upper edge layer node. The retrieval moves up towards the cloud 307 for the upgradation parameters if the upgradation parameters are not found at the upper edge layer node. In one non-limiting embodiment, if the upgradation parameters are not retrieved from the edge layer nodes 305 and the cloud 307, an alert is generated for the system administrator to provide the upgradation parameters required to update the on-senor model against the detected degradation.

The at least one processor 303 may be then configured to update the at least one on-sensor ML model based on the ML model upgradation parameters retrieved from one of the plurality of sources. The updated on-sensor ML model leads to accurate predictions and prevents plant shutdowns and re-deployments of ML sensors.

In an embodiment of the present disclosure, the at least one processor 303 may be configured to group one or more on-sensor ML models of the industrial plant at least based on a type of sensor, a type of on-sensor ML model, version of on-sensor ML model, tested accuracy of on-sensor ML model, and size of on-sensor ML model. The grouping may be carried out using the sensor segregator module 203, as discussed in explanation of FIG. 2 in above embodiments.

In an embodiment, the system 300 may also handle on request upgrading of an on-sensor ML model. The at least one processor 303 may be configured to receive a request for updating the on-sensor machine learning model from an end user. The on-sensor machine learning model may be embedded in the one of the pluralities of ML based sensors 309.

The request may comprise one or more application requirements from the ML based sensor 309 comprising the on-sensor machine learning (ML) model 311. The application requirement may comprise the details of the environment in which the ML based sensor is deployed or the additional application or use of the ML based sensor 309.

The at least one processor 303 may be configured to retrieve ML model upgradation parameters corresponding to the one or more application requirements from one of the plurality of sources. The at least one processor 303 may retrieve the upgradation parameters from one of: a local storage or memory 301, a distributed edge network, or cloud 307. The upgradation parameters corresponding to specific application requirement for a specific type of sensor may be pre-stored in one of a local storage or memory of the ML sensor, an edge network node 305, or cloud 307.

The retrieval of the ML model upgradation parameters may be carried out using top to bottom approach, where the ML model upgradation parameters will be first retrieved from the cloud 307. If the ML model upgradation parameters are not present with the cloud 307, then the retrieval is carried out from the upper edge node. If the ML model upgradation parameters are not present with the upper edge node, then the retrieval is carried out from the lower edge node.

In one non-limiting aspect, the at least one processor 303 may be configured to transmit the retrieved ML model upgradation parameters to respective ML based sensors for training the on-sensor ML model.

Thus, the system 300 increases the adaptability of ML based sensors to changing conditions/application requirement in an industrial environment. Further, the system efficiently manages the performance of the on-sensor ML models, thereby leading to accurate predictions and preventing plant shutdowns and re-deployments. In addition, on-sensor ML models of the smart sensor are maintained and updated from time to time to provide continuous accurate predictions.

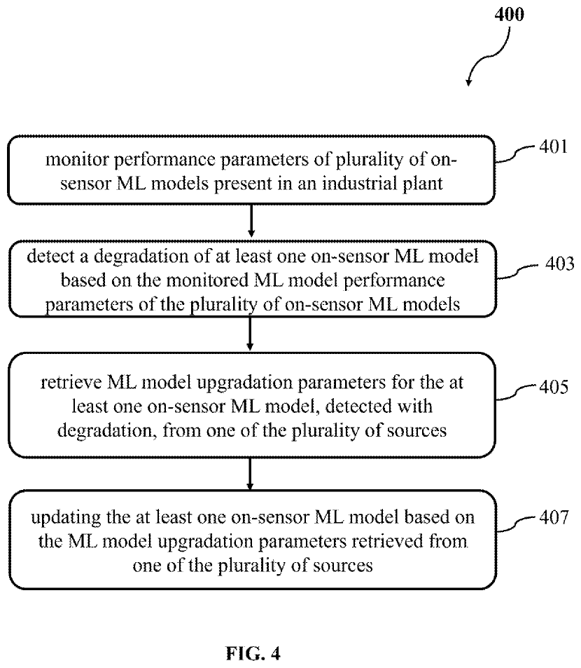

FIG. 4 is a flowchart illustrating a method for managing an on-sensor machine learning (ML) model, in accordance with an embodiment of the present disclosure.

The method 400 depicted in the flow diagram may be performed by, for example, the at least one processor 303 shown in FIG. 3. Operations of the flow diagram, and combinations of operation in the flow diagram, may be implemented by, for example, hardware, firmware, a processor, circuitry and/or a different device associated with the execution of software that includes one or more computer program instructions. The operations of the method 400 may also be performed by the on-sensor analytics module 201, the sensor segregator module 203, and the sensor upgrader module 205 shown in FIG. 2. It is noted that the operations of the method 400 can be described and/or practiced by using one or more processors of a system/device other than discussed in above embodiments.

At step 401, the method 400 discloses monitoring performance parameters of plurality of on-sensor ML models present in an industrial plant. In one non-limiting embodiment, monitoring the performance parameters comprises monitoring input and output parameters of the on-sensor ML model of each ML based sensor.

At step 403, the method 400 discloses detecting a degradation of at least one on-sensor ML model based on the monitored ML model performance parameters of the plurality of on-sensor ML models. The degradation of the on-sensor ML model comprises one or more of: data distribution change, training serving skew, model drift, occurrence of outlier event, and data quality issue. The detection of the degradation may be carried out using the procedure discussed in above embodiments with respect to FIGS. 2 and 3.

At step 405, the method 400 discloses retrieving ML model upgradation parameters for the on-sensor ML model, detected with degradation, from one of the plurality of sources. The plurality of sources may be one of: a local storage of the ML based sensor, a distributed edge network node, or cloud. To retrieve the ML model upgradation parameters for the at least one on-sensor ML model from the distributed edge network, the method 400 comprises retrieving ML model upgradation parameters for the on-sensor ML model from an edge node of an edge layer of the distributed edge network.

The retrieving the ML model upgradation parameters for the at least one on-sensor ML model from the distributed edge network comprises retrieving ML model upgradation parameters for the at least one on-sensor ML model from an edge node of an edge layer of the distributed edge network. The distributed edge network comprises a plurality of edge layers, each edge layer comprises at least one edge node. At least one edge node of a lowest edge layer is coupled to at least one sensor comprising at least one on-sensor ML model, and the at least one edge node of the lowest edge layer is further coupled to at least one edge node of a higher edge layer. At least edge node of highest edge layer is coupled to the cloud, and the at least one edge node of the highest edge layer is coupled to at least one edge node of a lower edge layer.

The procedure of retrieval of the ML model upgradation parameters from the edge node is same as discussed in explanation of FIGS. 2 and 3 in above embodiments.

The retrieval procedure for the ML model upgradation parameters may be carried out using bottom to top approach, where the upgradation parameters are first retrieved from the local storage of the ML based sensor. If the upgradation parameters are not available with the ML based sensor, then an edge layer node next to the ML based sensor is alerted and the upgradation parameters are retrieved from the edge layer node next to the ML based sensor. If the upgradation parameters are not available with the edge layer node next to the ML based sensor, then an upper edge layer node present next to the previous edge layer node is alerted to retrieve the upgradation parameters from the upper edge layer node. The retrieval moves up towards the cloud for the upgradation parameters if the upgradation parameters are not found at the upper edge layer node. In one non-limiting embodiment, if the upgradation parameters are not retrieved from the edge layer nodes and the cloud, an alert is generated for the system administrator to provide the upgradation parameters required to update the on-senor model against the detected degradation.

At step 405, the method 400 discloses updating the at least one on-sensor ML model based on the ML model upgradation parameters retrieved from one of the plurality of sources. The updated on-sensor ML model leads to accurate predictions and prevents plant shutdowns and re-deployments of ML sensors.

In an embodiment of the present disclosure, the method 400 further discloses grouping one or more on-sensor ML models of the industrial plant at least based on a type of sensor, a type of on-sensor ML model, version of on-sensor ML model, tested accuracy of on-sensor ML model, and size of on-sensor ML model. The grouping may be carried out using the sensor segregator module 203, as discussed in explanation of FIG. 2 in above embodiments.

Thus, the method 400 increases the adaptability of ML based sensors to changing conditions in an industrial environment. Further, the method 400 efficiently manages the performance of the on-sensor ML models, thereby leading to accurate predictions and preventing plant shutdowns and re-deployments. In addition, on-sensor ML models of the smart sensor are maintained and updated from time to time to provide continuous accurate predictions.

The disclosed method with reference to FIG. 4, or one or more operations of the flow diagram 400 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

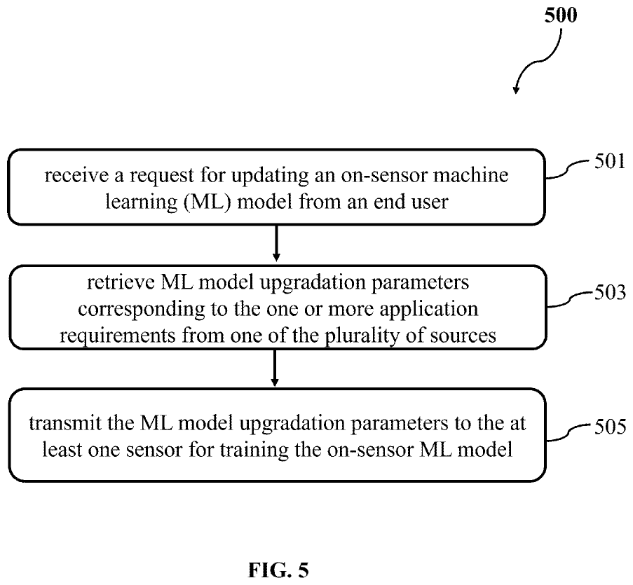

FIG. 5 is a flowchart illustrating a method for upgrading an on-sensor machine learning (ML) model, in accordance with an embodiment of the present disclosure.

The method 500 depicted in the flow diagram may be performed by, for example, the at least one processor 303 shown in FIG. 3. Operations of the flow diagram, and combinations of operation in the flow diagram, may be implemented by, for example, hardware, firmware, a processor, circuitry and/or a different device associated with the execution of software that includes one or more computer program instructions. The operations of the method 400 may also be performed by the on-sensor analytics module 201, the sensor segregator module 203, and the sensor upgrader module 205 shown in FIG. 2. It is noted that the operations of the method 400 can be described and/or practiced by using one or more processors of a system/device other than discussed in above embodiments.

At step 501, the method 500 discloses receiving a request for updating the on-sensor machine learning model from an end user. The on-sensor machine learning model may be embedded in the one of the pluralities of ML based sensors. The request may comprise one or more application requirements from the ML based sensor comprising the on-sensor machine learning (ML) model. The application requirement may comprise the details of the environment in which the ML based sensor is deployed or the additional application or use of the ML based sensor.

At step 503, the method 500 discloses retrieving ML model upgradation parameters corresponding to the one or more application requirements from one of the plurality of sources. The retrieving of the ML model upgradation parameters corresponding to the one or more application requirements comprises retrieving the upgradation parameters from one of: a local storage or memory, a distributed edge network, or cloud. The upgradation parameters corresponding to specific application requirement for a specific type of sensor may be pre-stored in one of a local storage or memory of the ML sensor, an edge network node 305, or cloud 307.

The retrieval of the ML model upgradation parameters may be carried out using top to bottom approach, where the ML model upgradation parameters will be first retrieved from the cloud. If the ML model upgradation parameters are not present with the cloud, then the retrieval is carried out from the upper edge node. If the ML model upgradation parameters are not present with the upper edge node, then the retrieval is carried out from the lower edge node.

At step 505, the method 500 discloses transmitting the retrieved ML model upgradation parameters to respective ML based sensors for training the on-sensor ML model. The retrieved ML model upgradation parameters may be used to train the on-sensor ML model with additional functionalities based on the application requirements provided by the end user.

Thus, the method 500 increases the adaptability of ML based sensors to changing application requirements and facilitates adapting to various other functionalities in an industrial environment. Thus, the method 500 increases the adaptability of ML based sensors to changing conditions/application requirement in an industrial environment.

The disclosed method with reference to FIG. 5, or one or more operations of the flow diagram 500 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

The terminologies “industry”, “industrial plant”, “process industry” and “power plant” have been interchangeably used throughout the specification.

The terminologies “Machine Learning (ML) Sensor” “ML based sensor”, “smart sensor” and “sensor” have been interchangeably used throughout the specification.

The terminologies “ML model” and “on-sensor ML model” have been interchangeably used throughout the specification.

The terminologies “edge layer nodes”, “edge node”, and “edge network node” have been interchangeably used throughout the specification.

Various embodiments of the present disclosure provide numerous advantages. Embodiments of the present disclosure provide a system for analyzing cybersecurity postures for an operation technology infrastructure. In addition, the present disclosure provides the system for generating a prioritization sequence for remediation of one or more vulnerable components of each plant.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERRAL NUMERALS

| Referral Number | Description |
|---|---|
| 100 | Environment |
| 101, 103, 105, 107 | ML based sensors |
| 110 | Distributed edge network |
| 111, 113, 115 | Lower edge node |
| 117, 119 | Upper edge node |
| 120 | Cloud |
| 200 | System |
| 201 | On-Sensor Analytics Module |
| 203 | Sensor Segregator Module |
| 205 | Sensor Upgrader Module |
| 300 | System |
| 301 | Memory |
| 303 | At least one Processor |
| 305 | One or more Edge node |
| 307 | Cloud |
| 309 | Plurality of ML sensors |
| 311 | Plurality of on-sensor ML models |
| 400 | Method |
| 401-407 | Method steps |
| 500 | Method |
| 501-505 | Method steps |

What is claimed is:

1. A method for managing an on-sensor machine learning (ML) model, the method comprising:
monitoring performance parameters of a plurality of on-sensor ML models present in an industrial plant;
detecting a degradation of at least one on-sensor ML model of the plurality of on-sensor ML models based on monitored ML model performance parameters of the plurality of on-sensor ML models, wherein the degradation of the at least one on-sensor ML model comprises at least one of: a data distribution change, a training serving skew, a model drift, an occurrence of an outlier event, and a data quality issue;
retrieving ML model upgradation parameters for the at least one on-sensor ML model, detected with degradation, from one of a plurality of sources; and
updating the at least one on-sensor ML model based on the ML model upgradation parameters retrieved from the one of the plurality of sources.

2. The method of claim 1, wherein detecting the degradation of the at least one on-sensor ML model comprises:
comparing each of input parameters and output parameters of the at least one on-sensor ML model with a respective threshold defined during training of the at least one on-sensor ML model;
performing one or more data distribution tests on the at least one on-sensor ML model to measure one or more data distribution changes using distance metrics;
determining a reduction in predictive performance of the at least one on-sensor ML model using one or more evaluation metrics; and
applying an outlier detection technique to determine one or more outlier event.

3. The method of claim 1, wherein retrieving the ML model upgradation parameters for the at least one on-sensor ML model comprises: retrieving ML model upgradation parameters for the at least one on-sensor ML model from one of: a local storage, a distributed edge network, or cloud.

4. The method of claim 3, wherein retrieving the ML model upgradation parameters for the at least one on-sensor ML model from the distributed edge network comprises retrieving ML model upgradation parameters for the at least one on-sensor ML model from an edge node of an edge layer of the distributed edge network, wherein the distributed edge network comprises a plurality of edge layers, each edge layer comprises at least one edge node, wherein at least one edge node of a lowest edge layer is coupled to at least one sensor comprising at least one on-sensor ML model, and the at least one edge node of the lowest edge layer is further coupled to at least one edge node of a higher edge layer, and wherein at least edge node of highest edge layer is coupled to the cloud, and the at least one edge node of the highest edge layer is further coupled to at least one edge node of a lower edge layer.

5. The method of claim 1, further comprising grouping one or more on-sensor ML models of the industrial plant at least based on a type of sensor, a type of on-sensor ML model, version of on-sensor ML model, tested accuracy of on-sensor ML model, and size of on-sensor ML model.

6. A method for upgrading an on-sensor machine learning (ML) model, the method comprising:
receiving a request for updating an on-sensor machine learning (ML) model from an end user, wherein the request comprises one or more application requirements from at least one sensor comprising the on-sensor machine learning (ML) model;
retrieving ML model upgradation parameters corresponding to the one or more application requirements from one of the plurality of sources; and
transmitting the ML model upgradation parameters to the at least one sensor for training the on-sensor ML model.

7. The method of claim 6, wherein the retrieving the ML model upgradation parameters corresponding to the one or more application requirements comprises: retrieving ML model upgradation parameters from one of: a local storage, a distributed edge network, or cloud.

8. The method of claim 7, wherein retrieving the ML model upgradation parameters corresponding to the one or more application requirements from the distributed edge network comprises retrieving ML model upgradation parameters corresponding to the one or more application requirements from an edge node of an edge layer of the distributed edge network, wherein the distributed edge network comprises a plurality of edge layers, each edge layer comprises at least one edge node, wherein at least one edge node of a lowest edge layer is coupled to at least one sensor comprising at least one on-sensor ML model, and the at least one edge node of the lowest edge layer is further coupled to at least one edge node of a higher edge layer, and wherein at least edge node of highest edge layer is coupled to the cloud, and the at least one edge node of the highest edge layer is further coupled to at least one edge node of a lower edge layer.

9. A system for managing an on-sensor machine learning (ML) model, the system comprising:
a memory;
at least one processor coupled to the memory, wherein the at least one processor is configured to:
monitor performance parameters of plurality of on-sensor ML models present in an industrial plant;
detect a degradation of at least one on-sensor ML model based on the monitored ML model performance parameters of the plurality of on-sensor ML models, wherein the degradation of the at least one on-sensor ML model comprises at least one of: data distribution change, training serving skew, model drift, occurrence of outlier event, and data quality issue;
retrieve ML model upgradation parameters for the at least one on-sensor ML model, detected with degradation, from one of the plurality of sources; and
update the at least one on-sensor ML model based on the ML model upgradation parameters retrieved from one of the plurality of sources.

10. The system of claim 9, wherein for detecting the degradation of the at least one on-sensor ML model, the at least one processor is further configured to:
compare each of input parameters and output parameters of the at least one on-sensor ML model with respective threshold defined during training of the at least one on-sensor ML model;
perform one or more data distribution tests on the at least one on-sensor ML model to measure one or more data distribution change using distance metrics;
determine a reduction in predictive performance of the at least one on-sensor ML model using one or more evaluation metrics; and
apply an outlier detection technique to determine one or more outlier event.

11. The system of claim 9, wherein for retrieving the ML model upgradation parameters for the at least one on-sensor ML model, the at least one processor is further configured to retrieve ML model upgradation parameters for the at least one on-sensor ML model from one of: a local storage, a distributed edge network, or cloud.

12. The system of claim 11, wherein for retrieving the ML model upgradation parameters for the at least one on-sensor ML model from the distributed edge network, the at least one processor is configured to:
retrieve ML model upgradation parameters for the at least one on-sensor ML model from an edge node of an edge layer of the distributed edge network,
wherein the distributed edge network comprises a plurality of edge layers, each edge layer comprises at least one edge node,
wherein at least one edge node of a lowest edge layer is coupled to at least one sensor comprising at least one on-sensor ML model, and the at least one edge node of the lowest edge layer is further coupled to at least one edge node of a higher edge layer, and
wherein at least edge node of highest edge layer is coupled to the cloud, and the at least one edge node of the highest edge layer is further coupled to at least one edge node of a lower edge layer.

13. The system of claim 9, wherein the at least one processor is further configured to group one or more on-sensor ML models of the industrial plant at least based on a type of sensor, a type of on-sensor ML model, version of on-sensor ML model, tested accuracy of on-sensor ML model, and size of on-sensor ML model.

14. A system for upgrading an on-sensor machine learning (ML) model, the method comprising:
a memory; and
at least one processor coupled to the memory, wherein the at least one processor is configured to:
receive a request for updating an on-sensor machine learning (ML) model from an end user, wherein the request comprises one or more application requirements from at least one sensor comprising the on-sensor machine learning (ML) model;
retrieve ML model upgradation parameters corresponding to the one or more application requirements from one of the plurality of sources; and
transmit the ML model upgradation parameters to the at least one sensor for training the on-sensor ML model.

15. The system of claim 14, wherein for retrieving the ML model upgradation parameters corresponding to the one or more application requirements, the at least one processor is configured to retrieve ML model upgradation parameters from one of: a local storage, a distributed edge network, or cloud.

16. The system of claim 15, wherein for retrieving the ML model upgradation parameters corresponding to the one or more application requirements from the distributed edge network, the at least one processor is further configured to:
retrieve ML model upgradation parameters corresponding to the one or more application requirements from an edge node of an edge layer of the distributed edge network,
wherein the distributed edge network comprises a plurality of edge layers, each edge layer comprises at least one edge node,
wherein at least one edge node of a lowest edge layer is coupled to at least one sensor comprising at least one on-sensor ML model, and the at least one edge node of the lowest edge layer is further coupled to at least one edge node of a higher edge layer, and
wherein at least edge node of highest edge layer is coupled to the cloud, and the at least one edge node of the highest edge layer is further coupled to at least one edge node of a lower edge layer.
